(19) United States
(12) Patent Application Publication
(10) Pub. No.: US 2019/0359119 A1
(43) Pub. Date: Nov. 28, 2019

(54) ADAPTIVE LIGHT BEAM UNIT AND USE OF SAME

(71) Applicant: 2948-4292 QUEBEC INC., Valcourt (CA)

(72) Inventor: Walter BROUILLARD-TURGEON, Saint-Damase (CA)

(21) Appl. No.: 16/472,639

(22) PCT Filed: Dec. 21, 2017
(86) PCT No.: PCT/CA2017/051583

§ 371 Date: Jun. 21, 2019

Related U.S. Application Data
(60) Provisional application No. 62/437,715, filed on Dec. 22, 2016.

(51) Int. Cl. B60Q 1/10; F21S 41/30; B60Q 1/04

(52) U.S. Cl. CPC B60Q 1/10; F21S 41/30; B60Q 1/0483; B60Q 2900/10; B60Q 2300/31; B60Q 2300/114; B60Q 2300/13

(57) ABSTRACT

An adaptive light beam unit attachable to a vehicle including: At least one light engine assembly, wherein the at least one light engine assembly includes at least one light engine, the at least one light engine includes at least one light source and at least one reflector adapted to reflect light emitted from the at least one light source to form a light beam; At least one sensor for measuring angle of rotation of the vehicle; At least one motor connected to the at least one light engine assembly for changing a projection angle of the light beam; At least one controller operatively connected to the least one light engine assembly and the at least one sensor, whereby the at least one controller receives information on the angle of rotation of the vehicle, and drives the at least one electrical motor to maintain or alter the projection angle of the light beam such that a desired lighting positioning is obtained based on a pre-determined scenario.

### FIELD OF THE DISCLOSURE

The current disclosure relates generally to a self or intelligent adaptive light beam unit for vehicles, and in particular, off-road vehicles and the like. A reflective body that reflects light from a single LED or an array of LEDs is motorized (and in one alternative is non-motorized) to achieve a light beam projection to reduce, preferably eliminate, the (negative visual) impact of conditions, (particularly off-road conditions) caused by snow fall, sand dust, general dust, vehicle pitch variation due to deceleration or acceleration and approaching vehicles.

### BACKGROUND

Most motor vehicles are equipped with a fixed light source that produces only two light patterns, low and high beam patterns, and the operator is generally required to switch between the low and high beam patterns manually. Auxiliary lighting is often used to improve visibility during nighttime driving and inclement weather. However, if auxiliary lighting is used in improper alignment (too high, too low, too left, too right) with respect to the vehicle direction, or if the beam of light is too wide or too narrow, the auxiliary lighting may be inefficient or may even reduce visibility rather than improve visibility. There is a need for auxiliary lighting that is self or automatically (or intelligent) adaptive to various conditions and able to adjust the pitch, intensity and width of the light beam pattern to provide a more efficient usage of the light beam without the requirement of manual intervention. The self or intelligent adaptive light beam unit is particularly favourable to off-road conditions as it can rapidly adjust to compensate for the long suspension travel of off-road vehicles during braking and acceleration conditions.

Auxiliary lighting may also cause problems to other vehicle operators, such as blinding the operator of an approaching vehicle. There is a need for an self or automatic or intelligent adaptive light beam unit, which overcomes this drawback by detecting the light of an approaching vehicle and reducing the glare to the operator of the approaching vehicle. In addition, whiteout conditions (a wall of snow or sand that reflects light towards the operator of a vehicle—a weather condition in which visibility and contrast are severely reduced by snow or sand and the horizon disappears completely and there are no reference points at all, leaving the individual with a distorted orientation) are a common problem in winter for vehicle operators and particularly when travelling behind another vehicle. Other weather conditions such as wind can throw snow or sand in the air, reflecting light and reducing visibility. There is also a need for a self or automatic or intelligent adaptive light beam unit, which detects these conditions and adjusts automatically to reduce the effect of whiteout conditions or light reflection in snow/sand conditions.

Vehicles with standard suspension systems typically exhibit suspension travel of from 5 to 7 inches (and an angle variation of between 2-4 degrees), when encountering variations of road surface, typically paved road surface. Most passenger vehicles travel on roads which are fairly flat and therefore the suspension travel and angel of variation is sufficient in most cases to maintain proper lighting during travel.

In off-road vehicles, such as but not limited to quads and snowmobiles, the suspension travel is typically greater, such as but not limited to 10 to 40 inches (and the angle variation due to abrupt braking or acceleration may reach up but not limited to 10 to 18 degrees and more in some cases). The standard high beam/low beam option has limitations when used in off-road vehicles. There is a need for an auxiliary lighting unit with the ability to measure the angle of the light unit in relation to the surface of travel (for example but not limited to a gyroscope or the like). There is a need for a gyroscope or the like to be integral with the auxiliary lighting unit so there is no need to rely on sensors or measurements from the vehicle itself.

Light emitting diode (hereinafter referred to as “LED” or “LEDs”) light engines and lighting in general have two key limitations in their design: heat dissipation and energy consumption. Most off-road or all-terrain vehicles (“ATVs”) use magneto generators that cannot deliver high output wattage at low engine revolutions per minute. Therefore, if too many auxiliary lights are used on an off-road vehicle or ATV, the accumulator cannot recharge properly. The vehicles' power supply, whether it be a battery, generator or any other kind of electrical source, has a limited amount of energy and the addition of auxiliary lights will drain this energy if not used efficiently. There is therefore also a need to overcome some of these drawbacks by monitoring the temperature of a light source, such as a LED(s) from a single (or array of) heat sink thermal sensor(s) and turning the light source, such as a LED(s) on or off to allow for heat dissipation and energy conservation.

There is a need for a self or automatic or intelligent adaptive light beam unit which allow adjustment of the projection angle (herein understood throughout to include vertical and horizontal angles as well as projection pattern of the light beam) and/or position of the light beam without the need for the vehicle operator to manually turn on and off a switch such as an electrical or mechanical switch.

There is a need for a self or automatic or intelligent adaptive light beam unit wherein the operator is not required to let go the steering wheel or the handlebar, of a vehicle with a light beam unit, to switch from a high/low beam position, which may increase the safety of the vehicle, especially in difficult operating conditions that may be encountered with some off-road vehicles. Also, there is a need for such autonomous adaptive light beam unit to switch quickly in reaction to various conditions (pitch, yaw, roll, incoming light etc.), while respecting the limits of power from the power source of the light beam unit and/or magneto generators of various vehicles such as off-road vehicles.

There is a need for such an autonomous adaptive unit, packaged in a single housing, making it possible to install such device on various existing and new off-road vehicles, even being transportable from a vehicle to another.

There is furthermore a need to have an adaptive light beam unit which is autonomous from the vehicles on which it is installed other than for the voltage and current supplied by the vehicle in some configurations. For example, there is a need for such adaptive light beam unit which can function without receiving speed or angular information (pitch, roll or yaw) from the vehicle on which it is installed but rather receive this information from the unit itself.

There is also a need for such autonomous adaptive light beam unit to be packaged in a single housing that can be easily attached to vehicles, using only AC power or DC power from the vehicle.

There is a need for an adaptive light beam unit which can be packaged in a single casing, so as to diminish the risk to the unit from infiltration of water, dirt or dust within the casing, which may cause failure of the device.

Finally, there is a need for such adaptive light beam unit to include wireless communication means, allowing input to and/or output from the device, for example to modify the reaction parameters of the adaptive light beam unit (delays, maximum angles and gains on the signals to be processed) and/or to provide information to the user on a remote wireless device.

### SUMMARY

According to one aspect, there is provided an adaptive light beam unit attachable to a vehicle, comprising at least one light engine assembly, said at least one light engine assembly comprising at least one light engine, in exemplary embodiments a plurality of light engines, said at least one light engine comprising least one light source and at least one reflector, proximate said at least one light source, adapted to reflect light emitted from said at least one light source to project a light beam, in exemplary embodiments a directional light beam. Said at least one light source may be selected from the group consisting of at least one, in exemplary embodiments a plurality of, a LED, high intensity discharge lamp, organic LED, laser exiting phosphor, xenon lamp and combinations thereof The material of said at least one reflector may be selected from the group consisting of polished aluminium, metalized plastic, reflecting synthetic material, object coated by physical vapor deposition, ceramic reflective coating, high reflective metallic coating and combinations thereof. The shape of said at least one reflector may be selected from the group consisting of parabolic, spherical, flat plane, hyperbolic, ellipsoidal, and combinations thereof and a custom shape for a custom light diffusion pattern.

According to yet another embodiment, there is provided an adaptive light beam unit, attachable to a vehicle, the adaptive light beam unit comprising: at least one light engine assembly, wherein said at least one light engine assembly comprises at least one light engine, said at least one light engine comprises at least one light source and at least one reflector adapted to reflect light emitted from said at least one light source to form a light beam; at least one sensor for measuring angle of rotation of said vehicle; and at least one controller operatively connected to said least one light engine assembly and said at least one sensor, whereby said at least one controller receives information on said angle of rotation of said vehicle, and drives the adaptive light beam unit for maintaining and/or altering a projection angle of said light beam such that a desired lighting positioning is obtained based on a pre-determined scenario.

According to yet another embodiment, there is provided an adaptive light beam unit, attachable to a vehicle, the adaptive light beam unit comprising at least one light engine assembly, wherein said at least one light engine assembly comprises at least one light engine, said at least one light engine comprises at least one light source and at least one reflector adapted to reflect light emitted from said at least one light source to form a light beam; at least one sensor for measuring angle of rotation of said vehicle; at least one motor connected to said at least one light engine assembly for changing a projection angle of said light beam; and at least one controller operatively connected to said least one light engine assembly and said at least one sensor, whereby said at least one controller receives information on said angle of rotation of said vehicle, and drives said at least one motor to maintain and/or alter said projection angle of said light beam such that a desired lighting positioning is obtained based on a pre-determined scenario.

The adaptive light beam unit further comprises at least one controller, operatively connected to said at least one light engine assembly and at least one primary sensor for receiving information. In one embodiment, said information comprises at least one angle of rotation of a vehicle, such as pitch, roll or yaw. Said at least one angle of rotation when measured by said at least one primary sensor, drives at least one motor, preferably an electrical motor, connected to said at least one light engine assembly, to maintain or alter a projection angle of the light beam such that a desired lighting positioning is obtained based on pre-determined scenarios. Said at least one controller is selected from the group consisting of at least one, preferably a plurality of, microcontroller, programmable logic controller, complex programmable logic device, programmable logic device, application-specific integrated circuit, a combination of an analogue comparator and a logic device, and combinations thereof.

In another embodiment said adaptive light beam unit further comprises at least one secondary sensor for measuring incident lighting intensity on said adaptive light beam unit and sending measurement of said incident lighting intensity to said at least one controller, and wherein said at least one controller receives information on said incident lighting intensity and drives the at least one electrical motor altering said projection angle of said light beam when said incident lighting intensity is above a pre-determined threshold.

In yet another embodiment, said adaptive light beam unit further comprises at least one tertiary sensor for measuring temperature of said at least one light engine assembly and sending measurement of said temperature to said at least one controller, and wherein said at least one controller receives information on said measurement of said temperature and sends at least one command to the controller to alter power of said at least one light engine assembly such that a desired thermal range (and/or temperature range) of said at least one light engine assembly is maintained.

In yet another embodiment, said adaptive light beam unit further comprises at least one quaternary sensor for measuring at least one of acceleration, g-force and incident lighting, and wherein said controller receives information on at least one of said acceleration, g-force and incident lighting and said controller sends a command to select one of said at least one light source such that appropriate desired angle of diffusion of light, from said at least one light source, is selected.

Each of said sensors may be selected from the group consisting of at least one, in exemplary embodiments a plurality, of thermal sensor, light sensor, 3-axis accelerometer, input voltage sensor, gyroscope sensor and combinations thereof.

In one embodiment, the primary, secondary, tertiary and quaternary sensors are an integral unit.

In another embodiment, said adaptive light beam unit is self-adjusting based on conditions encountered.

In another embodiment, said adaptive light beam unit is intelligent.

In another embodiment, said adaptive light beam automatically adjusts itself in respect of light intensity, light path, light direction, depending on conditions encountered.

In another embodiment, said adaptive light beam unit is autonomous or self contained in that the light engine assembly(ies), controller(s), sensor(s), motor(s) are contained within one housing allowing facile installation on a vehicle as well as no reliance on the vehicle for any measurements or control of the adaptive light beam unit.

In one embodiment, said adaptive light beam unit is powered by the vehicle. In yet another embodiment, said adaptive light beam unit is powered by a power source independent of said vehicle, preferably a power source contained within said unit.

In one embodiment, said vehicle provides electric power to said at least one light engine, said at least one sensor, said at least electrical motor and said at least one controller.

In one embodiment, at least one battery provides electric power to said at least one light engine, said at least one sensor, said at least electrical motor and said at least one controller.

In one embodiment, said at least one light engine, said at least one sensor, said at least one electrical motor and said at least one controller are enclosed in a single housing.

In another embodiment, said adaptive light unit further comprises a wireless communication component which allows input of operational settings for said desired scenario into said controller.

In an exemplary embodiment, said wireless communication component allows output of said information from said controller.

In an exemplary embodiment, said wireless communication component is selected from a group consisting of Bluetooth, Wi-Fi, Wi-Fi HaLow and ZigBee communication modules.

According to yet another aspect, there is provided the use of the herein described at least one adaptive light beam unit mountable on at least one of an electric vehicle, plane, crane, boat, motor bike, bicycle, all-terrain vehicle, snowmobile, utility task vehicle, or a sport utility task vehicle.

According to yet another aspect, there is provided the use of the herein described at least one adaptive light beam unit on a person looking to engage or engaging in walking, running hiking, trekking or the like. Preferably the at least one adaptive light beam unit is mounted on the person according to mounting techniques known to persons skilled in the art, preferably on a garment or accessory to be used by the person.

According to yet another aspect, there is provided the use of the herein described at least one adaptive light beam unit on a motorized or non-motorized vehicle. Preferably said motorized or non-motorized vehicle may be a land vehicle, water vehicle, air vehicle, ice vehicle and combinations thereof. More preferably said motorized or non-motorized vehicle may be wheeled, non-wheeled, tracked, non-tracked and combinations thereof.

According to yet another aspect, there is provided an adaptive light beam unit wherein said reflector is rotatable in relation to said light source.

In one embodiment, said at least one light source is selected from a plurality of light sources in an array along an axis of rotation of said rotatable reflector.

In another embodiment, said at least one light source is selected from a plurality of light sources in an array normal to an axis of rotation of said rotatable reflector.

In yet another embodiment, said at least one light source is selected from a plurality of light sources in an array configured normal to and along an axis of rotation of said rotatable reflector.

In yet another embodiment, said at least one light source is selected from a plurality of light sources in an array along a length of the adaptive light beam unit.

In yet another embodiment, said at least one light source is selected from a plurality of light sources in an array normal to a length of the adaptive light beam unit.

In yet another embodiment, said at least one light source is selected from a plurality of light sources in an array configured normal to and along a length of the adaptive light beam unit.

In another embodiment, said at least one light source is selected from a plurality of light sources in an array emitting light toward said reflector.

In another embodiment, said at least one controller drives the lighting intensity of at least one light from said plurality of light sources.

One advantage of the described adaptive light beam unit is the projection angle of the light beam is numerous compared to a high beam/low beam standard light beam unit, accommodating a variety of road and weather conditions.

Another advantage of the described adaptive light beam unit is the automatic or intelligent adjustment of the light beam unit, with the use of a microprocessor or the like, allows for a light beam unit which adapts readily to the environment for the off-road vehicle and driver encountering terrain such as rough terrain in that the driver of the vehicle, such as an off-road vehicle, is not required to let go of the steering wheel or handle bar when light adjustment is required. This allows the driver to focus on the handling of the vehicle.

Another advantage of the described adaptive light beam unit, the microprocessor allows for rapid adjustment of the light beam unit according to the conditions measured allowing the driver to focus on directing the vehicle as needed.

### BRIEF DESCRIPTION OF THE DRAWINGS

FIG. 1A illustrates, according to one embodiment, a view of the adaptive light beam unit composed of a light engine assembly of three light engines;

FIG. 1B illustrates, according to one embodiment, a single light engine composed of an optical reflector and a single LED and an array of LEDs;

FIG. 1C-1 illustrates, according to one embodiment, a light engine assembly further comprising a pivot point;

FIG. 1C-2 illustrates, according to one embodiment, a variation of the embodiment of FIG. 1C-1;

FIG. 1D illustrates, according to one embodiment, a light engine assembly further comprising a support bracket;

FIG. 2A illustrates, according to one embodiment, a projection of the different light patterns that may be achieved with the adaptive light beam unit under one condition;

FIG. 2B illustrates, according to one embodiment, a projection of the different light patterns that may be achieved with the adaptive light beam unit under another condition;

FIG. 2C illustrates, according to one embodiment, a projection of the different light patterns that may be achieved with the adaptive light beam unit under yet another condition;

FIG. 3 illustrates, according to one embodiment, the internal correlation of each component of the adaptive light beam unit;

FIG. 4 illustrates, according to one embodiment, different light reflections of different positions of the LED inside the LED light engine;

FIG. 4A illustrates, according to one embodiment, an array of 3 LEDs running along the length of the adaptive light beam unit (and if motorized, along the axis of rotation of the reflector);

FIG. 4B illustrates, according to one embodiment, an array of 3 LEDs running normal to the length of the adaptive light beam unit (and if motorized, along the axis of rotation of the reflector);

FIG. 4C illustrates, according to one embodiment, an array of 5 LEDs running along and normal to the length of the adaptive light beam unit (and if motorized, along the axis of rotation of the reflector);

FIG. 4D illustrates, according to one embodiment, an array of 5 LEDs running along the length of the adaptive light beam unit (and if motorized, along the axis of rotation of the reflector);

FIG. 4E illustrates, according to one embodiment, an array of 2 LEDs running along the length of the adaptive light beam unit (and if motorized, along the axis of rotation of the reflector);

FIG. 4F illustrates, according to one embodiment, an array of 2 LED assemblies running along the length of the adaptive light beam unit, and if motorized along the axis of rotation of the reflector wherein each LED assembly comprises an array of smaller LEDs per assembly;

FIG. 5A illustrates, according to one embodiment, the flowchart of a controller embedded in the adaptive light beam unit;

FIG. 5B illustrates, according to one embodiment, a flowchart of a controller embedded in the adaptive light beam unit;

FIG. 5C illustrates, according to one embodiment, a flowchart of a controller embedded in the adaptive light beam unit;

FIG. 6 illustrates, according to one embodiment, the alternative current over the direct current when the magneto generator is running;

FIG. 7 illustrates, according to one embodiment, a flowchart in the microcontroller to calculate the LED output;

FIG. 8A illustrates, according to one embodiment, the signal from the front light sensor when the adaptive light beam unit is back lit by its own light;

FIG. 8B illustrates, according to one embodiment, the signal from the front light sensor when the adaptive light beam unit is lit by an approaching vehicle with its lights on;

FIG. 8C illustrates, according to one embodiment, the signal from the front light sensor after the adaptive light beam unit has traversed an approaching vehicle with its lights on.

FIG. 9A illustrates the light scattering pattern of the embodiment of FIG. 4A.

FIG. 9B illustrates the light scattering pattern of the embodiment of FIG. 4B.

FIG. 9C illustrates the light scattering pattern of the embodiment of FIG. 4C.

FIG. 9D illustrates the light scattering pattern of the embodiment of FIG. 4D.

FIG. 9E illustrates the light scattering pattern of the embodiment of FIG. 4E.

FIGS. 10A-10D illustrate the sequence, according to one embodiment, of the incident light sensor of vehicle A reacting to an approaching vehicle B.

### DETAILED DESCRIPTION

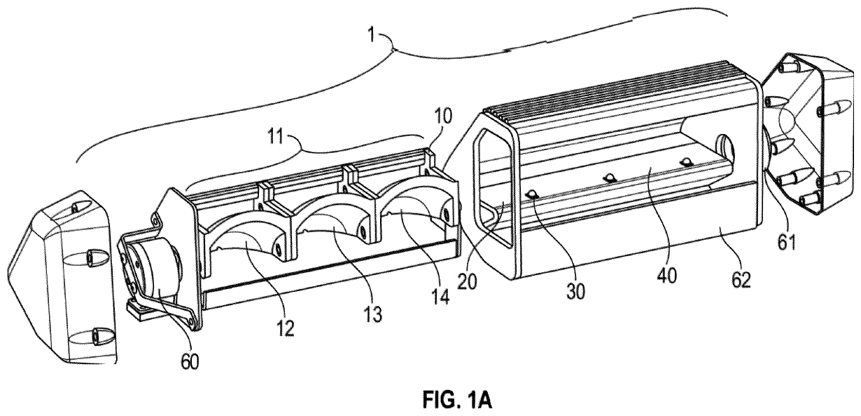

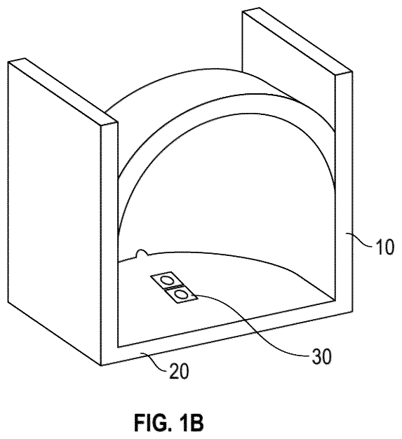

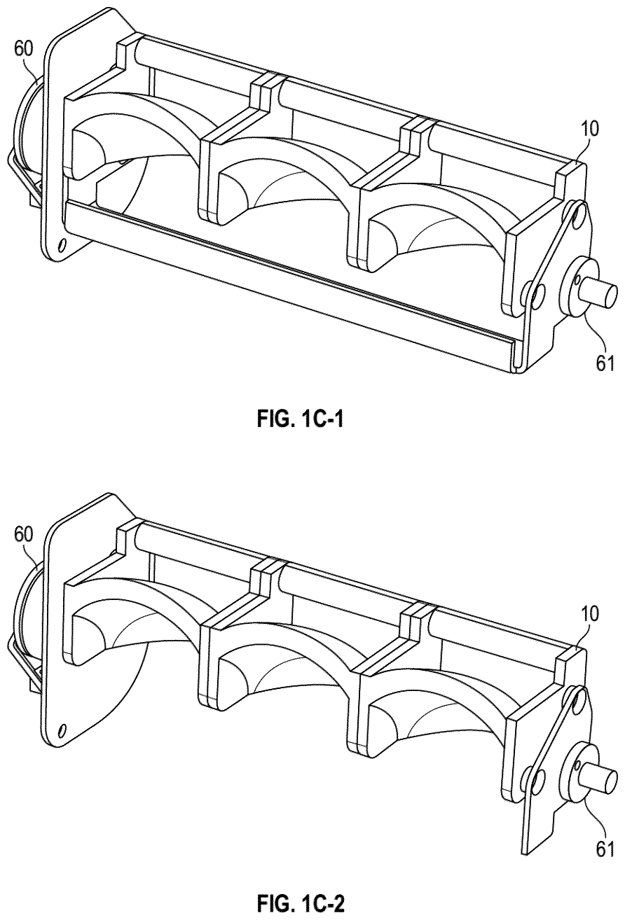

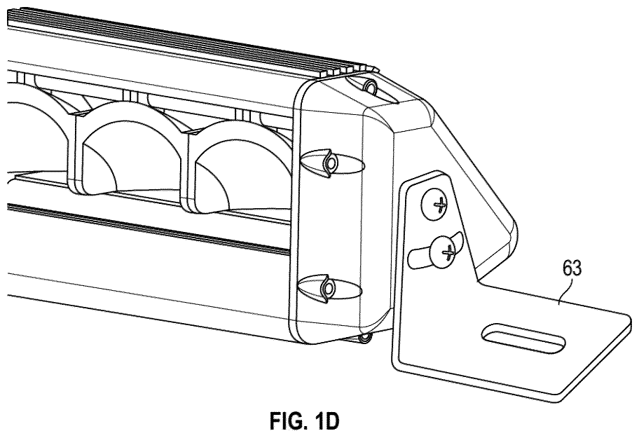

FIG. 1A illustrates a perspective view of an example of an adaptive light beam unit 1 composed of a light engine assembly 11 of three light engines 12, 13, 14 inside the adaptive light beam unit 1. The adaptive light beam unit 1 may be configured to have at least one light engine (as illustrated in FIG. 1B) or a plurality of light engines, as depicted in FIG. 1A, in order to achieve the desired light output. Preferably, for off-road vehicles, the number of LED lights in each light engine assembly may be selected from between 1 and 50 inclusive. Alternative examples of the adaptive light beam unit 1 may be achieved using high intensity discharge lamps, organic light emitting diodes, laser exiting phosphor, or xenon lamps instead of LEDs. Combinations of the abovementioned light sources may also be used.

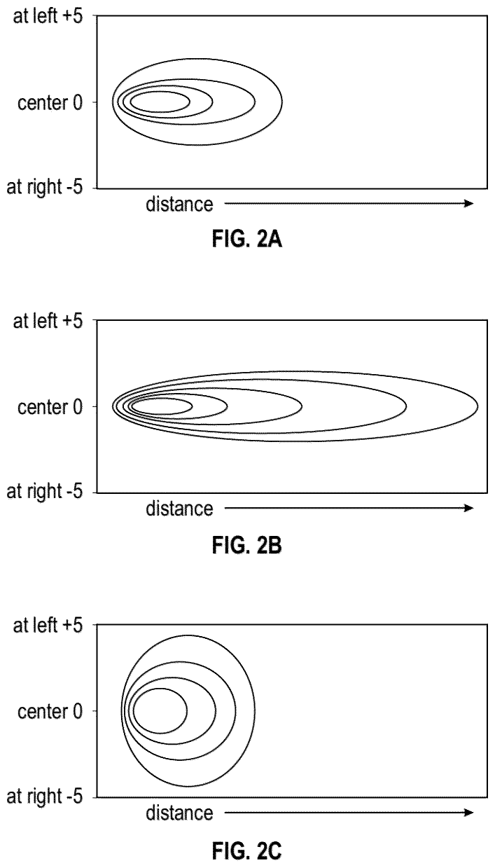

FIGS. 1A and 1B illustrate the components of the adaptive light beam unit 1. Each light engine (as illustrated in FIG. 1B) may include a single LED or an array of LEDs 30 installed within the light-source board 20 and reflector 10. The reflector 10 is to be reflective of the light source and may be composed of, for example, polished aluminium, metalized plastic, reflecting synthetic material, objects coated by physical vapour deposition processes, ceramic reflective coating, high reflective metallic coating or white reflective material (like ceramic), or a multitude of smaller reflector elements. The reflector may be composed of a surface with reflective properties. Each light engine (as illustrated in FIG. 1B) may be assembled together inside the adaptive light beam unit 1 to obtain a greater light output in a smaller package. FIG. 1A depicts three light engines. The reflector 10 reflects the light of each LED 30 in a controlled beam pattern to achieve a specific light dispersion, as further described below, and obtains an adapted output of the light beam unit. For example, if the reflector is at a mid-position, the light dispersion (in a static state) will be as shown in FIG. 2A. FIGS. 2B and 2C show the light dispersions (in a static state) when the reflector is at a high and low position, respectively.

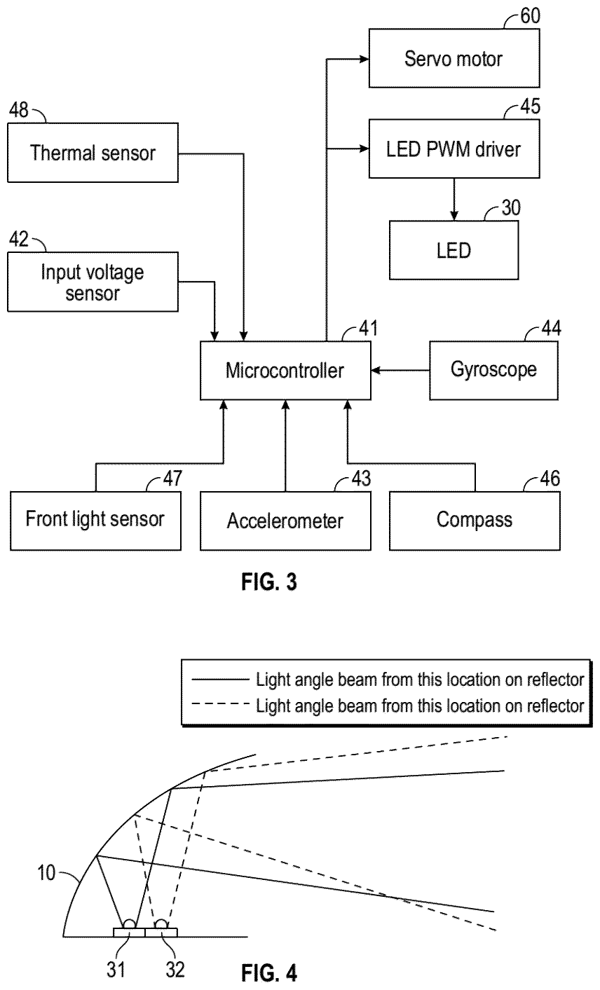

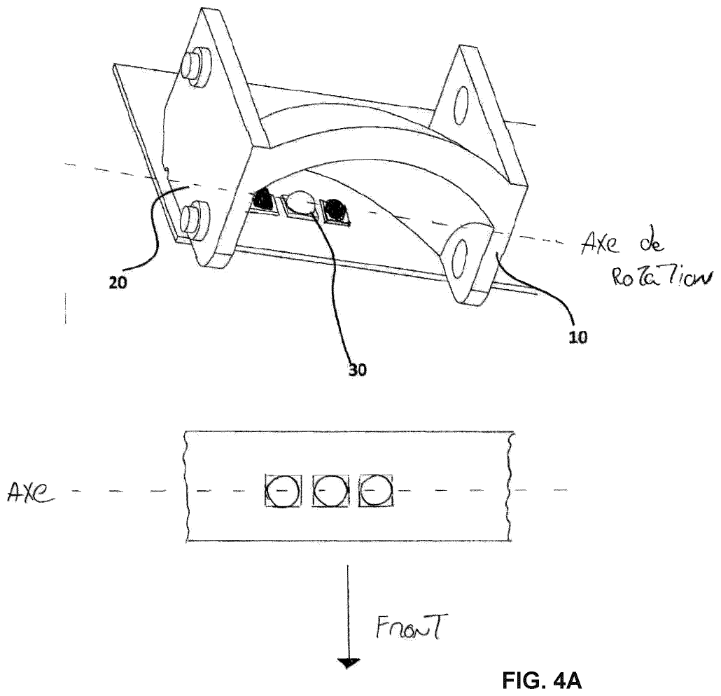

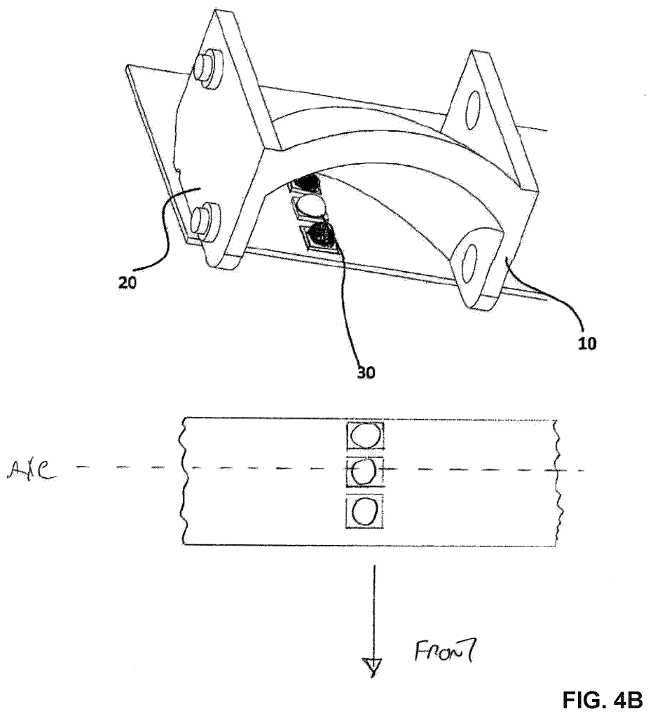

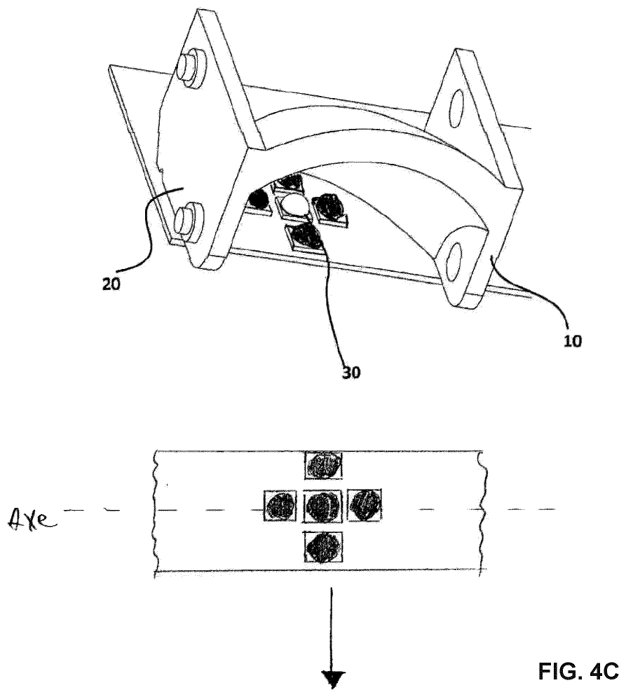

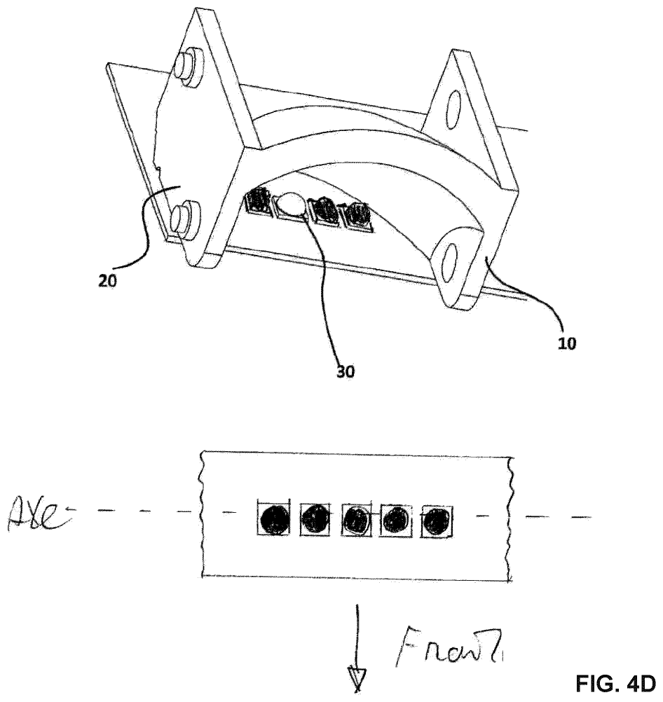

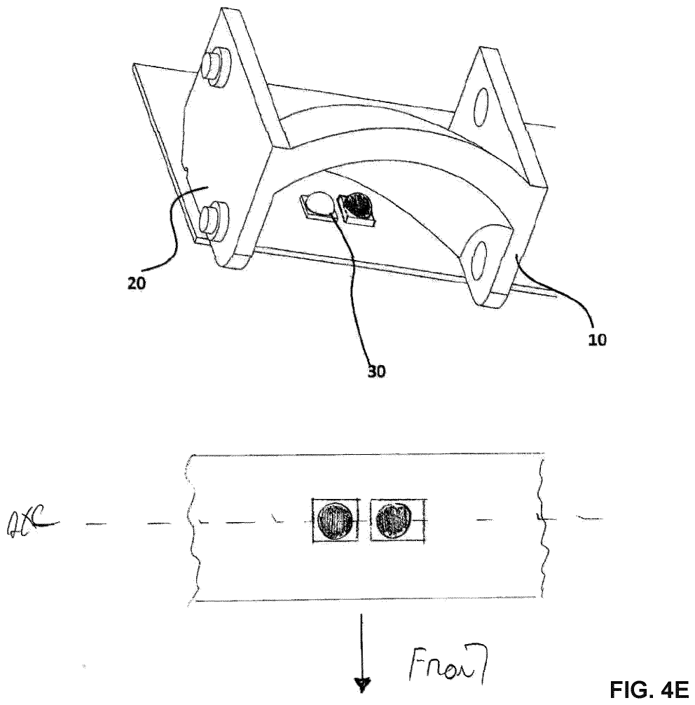

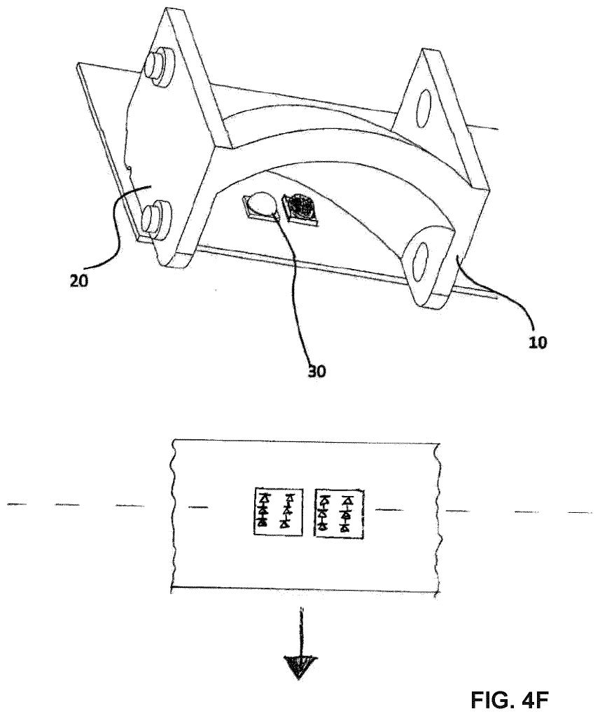

The reflector 10 may be parabolic, spherical, flat plane, hyperbolic, ellipsoidal, or a custom shape for a custom light diffusion pattern. Each light engine (as illustrated in FIG. 1B) may be produced with a reflector 10 of a specific curvature radius to achieve a specific adaptive light beam pattern. For example, a parabolic shape will produce a more concentrated light pattern and a spherical shape will produce a more diffused light pattern. All the light engines assemblies 11 are fixed together in a way to obtain a mechanical structure that can be supported by its own accord to the pivot point 61 (FIGS. 1C-1 and 1C-2). The light engines (as illustrated in FIGS. 1A and 1B) may be assembled and affixed by various methods, for example by screws, rivets, compression, welds and glue, a combination thereof and by various other methods of assemblies. The reflector 10 of the light engine assembly 11 may be rotated by a servomotor 60 to modify the vertical and/or horizontal direction of the light beam (See FIG. 4 elements 31 and 32). The rotation of the reflector 10 is determined, as more further explained below, by a controller depicted as a microcontroller 41 (FIG. 3) on the main board 40 (FIG. 1A), following a logic flowchart and mathematical calculation. Although in the current example, the controller is a microcontroller 41, programming may also be achieved using programmable logic controllers, complex programmable logic devices, programmable logic devices, application-specific integrated circuits, or a combination analogue comparators and logic devices, all of the above being controllers for such adaptive light beam unit 1.

FIG. 3 illustrates various input sensors, which in this example include the input voltage sensor 42, the accelerometer 43, the gyroscope sensor 44, the front light sensor 47 and the thermal sensors 48, which are processed by the microcontroller 41 which then controls the LEDs 30, LED power driver 45 and servomotor 60 based on pre-determined scenarios further described below. Optionally, a compass 46 may also provide input data to the microcontroller 41.

The rotation of the reflector 10 is achieved by using a servomotor 60 (FIGS. 1A and 1C), a brushless motor of any electro-mechanical device, and a microcontroller 41 to calculate the speed and reaction of the reflector. The microcontroller 41 is programmed to control the reflector's rotation to obtain the desired projection angle as a function of pre-determined scenarios. By selecting different LEDs 30 on the light-source board 20, the angle of the light beam may be modified almost instantly. The output of the adaptive light beam unit 1 may be boosted for a short period of time by powering all the LEDs 30 at maximum power if the temperature of the heat sink 62 is in adequate range. A single or an array of thermal sensors 48, such as, for example, thermistors (negative temperature coefficient thermistors or positive temperature coefficient thermistors), thermocouples, resistance thermometers and silicon bandgap temperature sensors, provide feedback to the microcontroller 41 to ensure that at any given time the LEDs 30 are working in an appropriate thermal range. For example, most LED chip components will be damaged if they run over 125 Celsius. The microcontroller 41 may reduce the power to each of the LEDs 30 by sending a command by pulse width modulation to the LED power driver 45. When the heat sink 62 of the adaptive light beam unit 1 has cooled, the thermal sensor 48 will allow the return to maximum LED power. For example, the following equation may be used to determine the relative value of a safe maximum output of the light engine (FIG. 1B) at any given time:

The safe maximum output (in percentage relative to the maximum output of the LED) at any given time=175−the value (in degrees C.°) of measured LED temperature. The maximum output will not exceed 100%.

Various materials may be used for the heat sink 62 in the abovementioned example, such as aluminium, gold, copper, silver, various alloys and combinations thereof. The adaptive light beam unit 1 illustrated herein is using the same heat dissipation for all LEDs. In this example, the heat sink 62 is cooled from the air moving naturally around it. Alternatively, the heat sink 62 may be cooled from water moving around it or by the inclusion of a system of forced air.

FIG. 4 illustrates how the positioning of the LED in relation to the reflector 10 produces different angles of diffusion. In the case of a parabolic reflector, if the LED is placed at the focus of the paraboloid 31, the reflection cone will be very narrow, if the LED is moved away from this position 32 the reflection cone will be extended on the two axes to make it more fit for low speeds. In this example, there are several LEDs installed within the light-source board 20 and the microcontroller 41 selects which LED are to be illuminated and which LED are to remain off to produce the desired angle of diffusion. The desired angle of diffusion is selected from pre-determined scenarios by the microcontroller. 41.

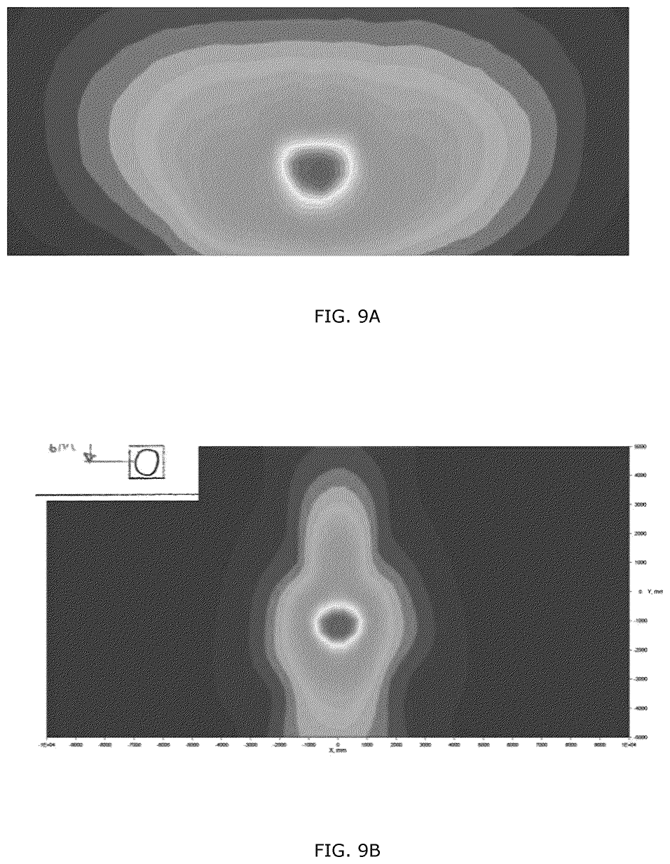

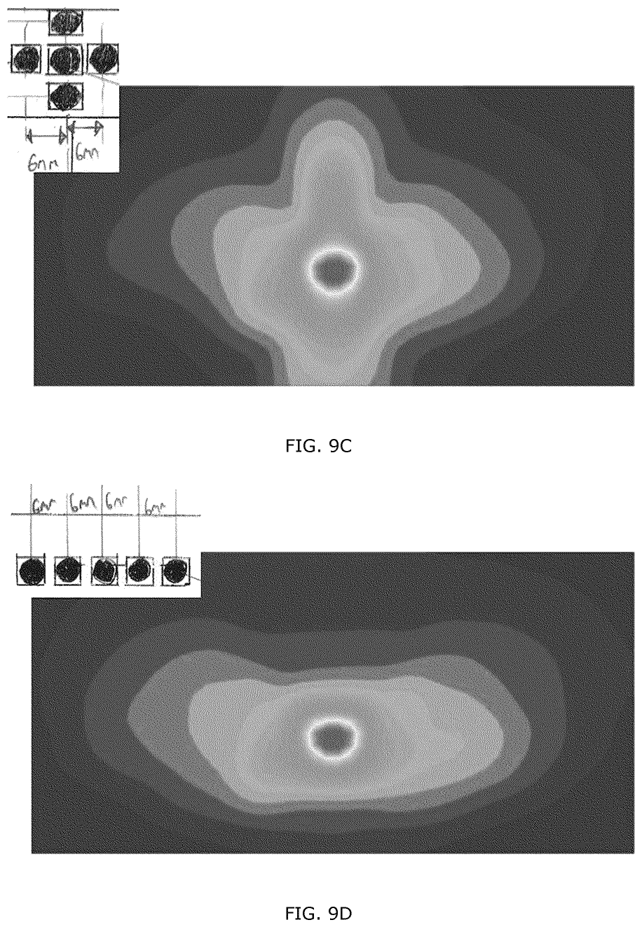

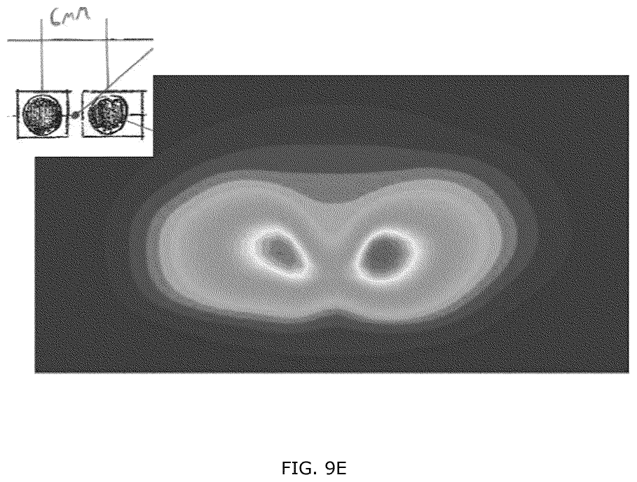

Referring now to FIG. 4A, 3 LEDs 30 on the light-source board 20 are in this embodiment aligned with the axis of rotation of the reflector 10. The microcontroller (not shown) will adjust the light intensity of each LED in the array based on the input from the sensors and the preprogrammed conditions of the unit 1. FIG. 9A depicts the light scattering diffusion pattern of this embodiment. The pattern depicts the light scattering pattern on a flat vertical surface of 20 meters by 10 meters at a distance of 10 meters from the light assembly. The LEDs on the light assembly are separated from each other at 6 millimeters centre to centre. The variation in colour depicts the degree of heat and intensity of the light on the flat vertical surface such as red being the hottest (most intense) and blue being the coolest (least intense).

Referring now to FIG. 4B, 3 LEDs 30 on the light-source board 20 are aligned normal to the axis of rotation of the reflector 10. This array alters the light scattering pattern that is more vertical in shape produced with the paraboloid shaped reflector than a light scattering pattern that would be produced with a flat or spherical reflector (not shown). FIG. 9B depicts the light scattering diffusion pattern of this embodiment. The pattern depicts the light scattering pattern on a flat vertical surface of 20 meters by 10 meters at a distance of 10 meters from the light assembly. The LEDs on the light assembly are separated from each other at 6 millimeters centre to centre. The variation in colour depicts the degree of heat and intensity of the light on the flat vertical surface such as red being the hottest (most intense) and blue being the coolest (least intense).

Referring now to FIG. 4C, 5 LEDs 30 on the light-source board 20 are arranged in a cross-like pattern with LEDs running normal and along the axis of rotation of the reflector. In this arrangement, the LEDs produce a light scattering pattern that is cross-like and the LEDs running longitudinally are useful for the upper and lower boundaries of the light scattering pattern. FIG. 9C depicts the light scattering diffusion pattern of this embodiment. The pattern depicts the light scattering pattern on a flat vertical surface of 20 meters by 10 meters at a distance of 10 meters from the light assembly. The LEDs on the light assembly are separated from each other at 6 millimeters centre to centre. The variation in colour depicts the degree of heat and intensity of the light on the flat vertical surface such as red being the hottest (most intense) and blue being the coolest (least intense).

Referring now to FIG. 4D, 5 LEDs 30 on the light-source board are arranged in a straight line along the axis of rotation of the reflector. This array allows for greater flexibility in controlling the light diffusion pattern by controlling the individual LEDs. FIG. 9D depicts the light scattering diffusion pattern of this embodiment. The pattern depicts the light scattering pattern on a flat vertical surface of 20 meters by 10 meters at a distance of 10 meters from the light assembly. The LEDs on the light assembly are separated from each other at 6 millimeters centre to centre. The variation in colour depicts the degree of heat and intensity of the light on the flat vertical surface such as red being the hottest (most intense) and blue being the coolest (least intense).

Referring now to FIG. 4E, 2 LEDs 30 on the light-source board are arranged in a straight line along the axis of rotation of the reflector. This array allows for limited flexibility in light diffusion pattern as desired by the user. FIG. 9E depicts the light scattering diffusion pattern of this embodiment. The pattern depicts the light scattering pattern on a flat vertical surface of 20 meters by 10 meters at a distance of 10 meters from the light assembly. The LEDs on the light assembly are separated from each other at 6 millimeters centre to centre. The variation in colour depicts the degree of heat and intensity of the light on the flat vertical surface such as red being the hottest (most intense) and blue being the coolest (least intense).

Referring now to FIG. 4F, there are 2 LED assemblies on the light-source board arranged in a straight line along the axis of rotation of the reflector. Each LED assembly is comprised of a matrix of smaller high powered LEDs wherein each high powered LED may be controlled. This arrangement allows for more LEDS in limited space.

In any of the above scenarios, with a reflector of a fixed shape and not movable, by modifying the configuration layout of the LEDs, the light scattering pattern may be modified. Furthermore, by modulating each LED, the light scattering pattern may be further modified without any mechanical movement but by only modulating each LED. One example would be to light the middle LED and not the lateral LEDs to create one pattern. Another example would be to light the lateral LEDS and not the middle LED to create a different light scattering pattern.

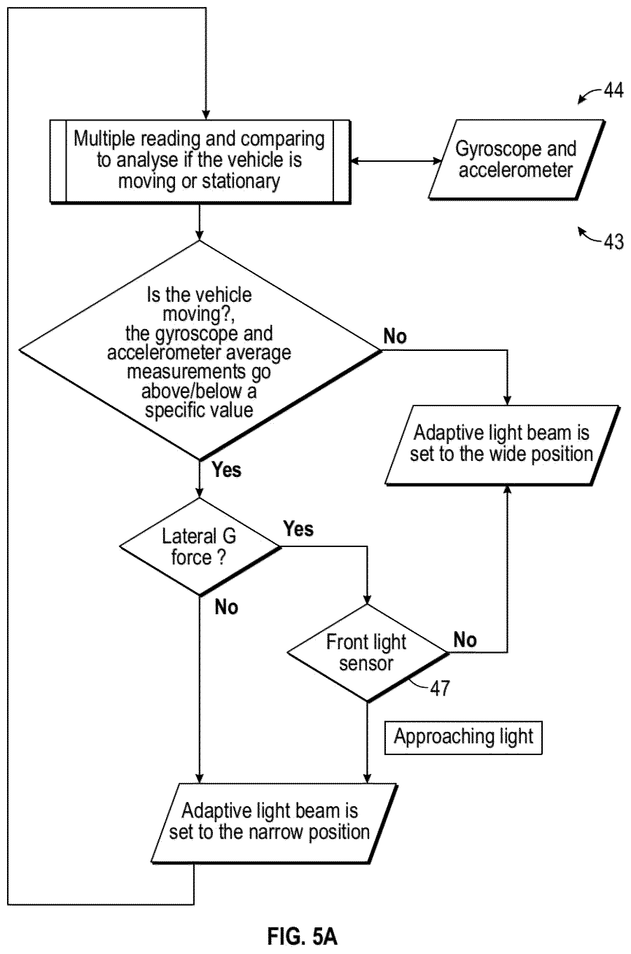

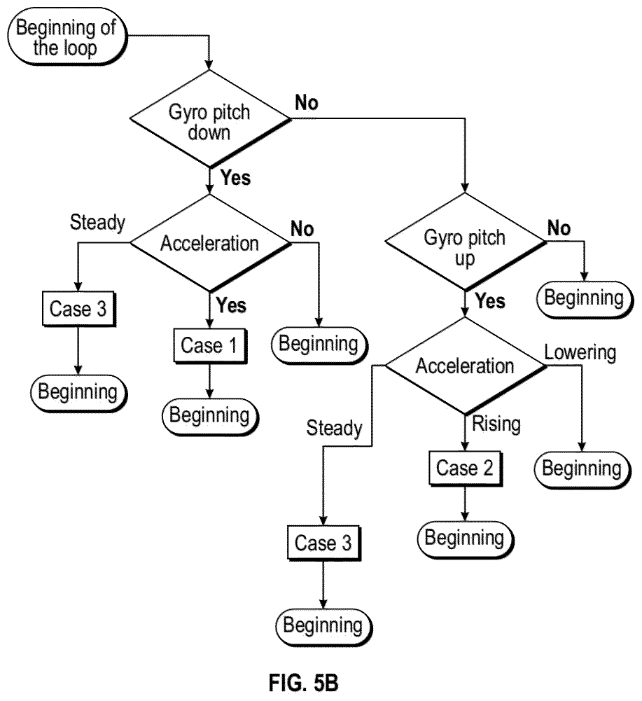

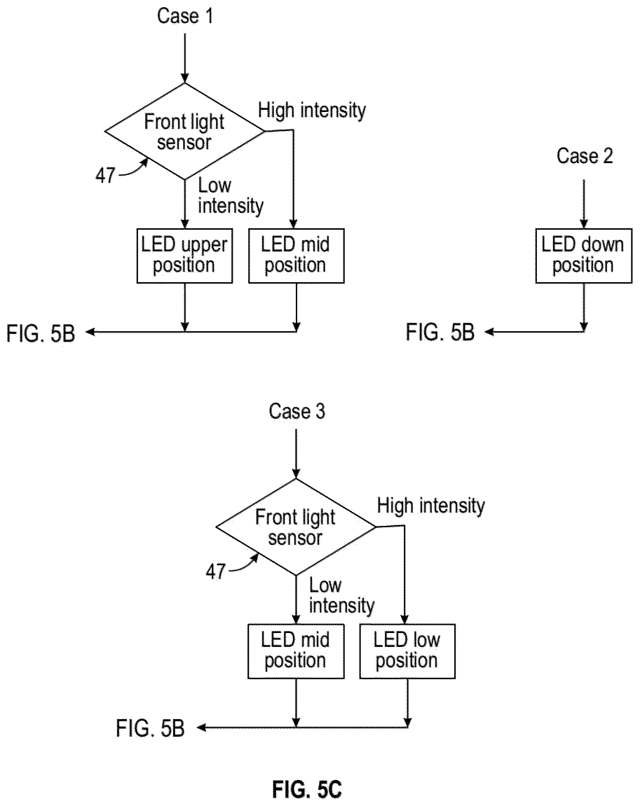

The flowchart (FIG. 5A) of the code in the microcontroller 41 describes how different angles of diffusion are selected. For example, if the gyroscope sensor 44 detects no change of angle and the accelerometer 43 detects no change in acceleration, then a stationary mode of the vehicle will be interpreted and the angle of diffusion will be set to a wide position. If the accelerometer 43 detects acceleration, but little change of angle is detected by the gyroscope sensor 44, the microcontroller will interpret normal driving conditions and will set the angle of diffusion as a function of these driving conditions, for example to provide a narrower beam. When a change in the lateral direction is detected by the gyroscope sensor 44, through an augmentation in the lateral G forces, the angle of diffusion will be set to provide a beam adapted to these driving conditions, for example a wider beam. However, if the front light sensor 47 detects light from an approaching vehicle, the angle could be automatically set to a narrower beam to avoid blinding

In the example described herein, a calibration step may be required upon installation to ensure proper performance of the adaptive light beam unit 1. In the case where a calibration step is required, the operator first proceeds with the mechanical setup of the height and the direction of a support bracket 63 (FIG. 1D), then a calibration mode is selected to lock the light beam of the adaptive light beam unit 1 in a middle position. The calibration mode may be selected by an external input, for example, by a dedicated wire or input in the connector, a button on the adaptive light beam unit 1, or by reversing the polarity of the supply. When the adaptive light beam unit 1 is in a calibration mode, the operator may set the desired height of the beam because the orientation of the beam is locked in the middle position. Once the calibration is complete, the adaptive light beam unit 1 may store the value of the gyroscope sensor 44 and accelerometer 43 in a non-volatile memory for later use. The operator simply needs to reset the adaptive light beam unit 1 by cycling the power input without the need to use an external input, such as a button, connecting the dedicated wire or by reversing the polarity of the supply.

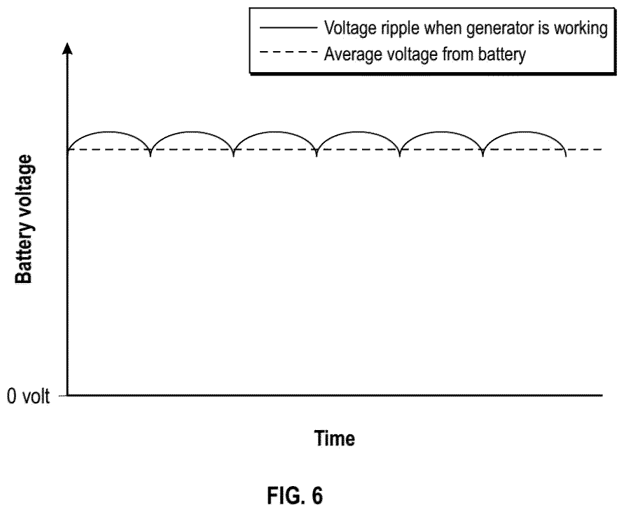

The flowcharts (FIG. 5B and FIG. 5C) of the code in the microcontroller 41 (FIG. 3) describes the typical reaction of the adaptive light beam unit 1 under normal conditions. An electronic circuit (input voltage sensor) 42 (FIG. 3) on the main board 40 (FIG. 1A) detects that the engine is running by the alternate current (AC) wave over the direct current (DC) voltage (FIG. 6), then the microcontroller 41 reads the other input sensors, which are, in this example, a gyroscope sensor 44 (FIG. 3) and an accelerometer 43 (FIG. 3) to detect a change in the pitch of the vehicle. If a downward change in the pitch is detected, the second logic gate is to detect whether the vehicle is accelerating or braking. If the vehicle is braking and the pitch is downward, the microcontroller 41 verifies whether the front light sensor 47 (FIG. 3) detects incoming light from an approaching vehicle, if yes, the microcontroller 41 orders the light reflector 10 to aim in a mid-position, if no light from an approaching vehicle is detected, the microcontroller 41 orders the light reflector 10 to aim in an upper position to compensate for the downward nose pitching caused by the brake application. In another scenario, if the microcontroller 41 detects a downward pitch but no deceleration is detected, the microcontroller 41 verifies if the front light sensor 47 detects incoming light from an approaching vehicle. If no light from an approaching vehicle is detected, the microcontroller 41 orders the light reflector 10 to a mid-position. If light from an approaching vehicle is detected, the microcontroller 41 orders the light reflector 10 to aim in a lower position to avoid blinding the approaching vehicle. In another scenario, if the microcontroller 41 detects an upward pitch and heavy acceleration, the microcontroller 41 orders the light reflector 10 to a lower position regardless of the front light sensor 47 reading. However, if the microcontroller 41 detects an upward pitch and no change in acceleration is detected, the microcontroller 41 verifies whether the front light sensor 47 detects incoming light from an approaching vehicle. If no light from an approaching vehicle is detected, the microcontroller 41 orders the light reflector 10 to a mid-position. If light from an approaching vehicle is detected, the microcontroller 41 orders the light reflector 10 to aim to a lower position to avoid blinding the approaching vehicle. As will be understood by a person skilled in the art, the above description, the upper, mid and lower positions may refer to either pre-set positions, or to an infinite number of intermediary positions within the range of angles of the unit. For example, the upper and lower positions may vary as a function of the pitch of the vehicle (i.e. higher pitch will correspond to higher angles).

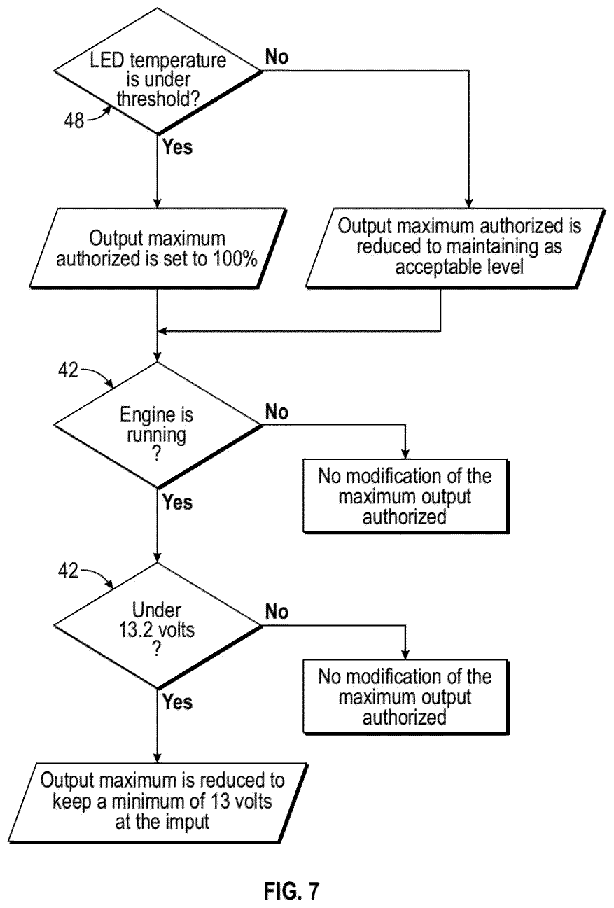

The LED power output may be determined by various elements (FIG. 7): engine RPM, battery voltage, and LED temperature. The voltage input sensor 42 can measure both engine RPM and/or average voltage input. The thermal sensor 48 measures the LED temperature. When the microcontroller 41 detects that an engine is running by detecting the AC voltage wave over the DC voltage (FIG. 6) with an electronic circuit (input voltage sensor) 42 on the main board 40, the LED power is reduced to retain the energy to recharge the battery. For example, if the battery input voltage drops under a predetermined level, in this example 13.2 volts, the LED output may be reduced to 50% of the reduced supply current of the adaptive light beam unit 1. When the microcontroller 41 detects an engine RPM increase or a voltage increase to the minimum battery charge voltage, for example, at 13.4 volts, the microcontroller 41 may allow for maximum output to the LED 30. In such cases, the priority of the microcontroller 41 is to keep the LED temperature under the maximum admissible temperature specified by the LED manufacturer.

The rate of change in the power output to the LED 30 is constrained when the vehicle is in stationary mode to reduce the visual perception (flickering) when there is fluctuation between the reduced output and the maximum output. For example, while a rate of change, in the power output to the LED 30, of 0.5 to 10% per second may be utilized, a rate of change of 1 to 3% may reduce the frequency of the flicker and provide more visual comfort to the vehicle operator.

In an alternative example, if there is no AC signal over DC supply read by the electronic circuit (input voltage sensor) 42, such as is the case with some electric vehicles, the adaptive light beam unit 1 will allow for full power to the LED 30.

The microcontroller 41 of the adaptive light beam unit 1 receives signals from sensors which sense the conditions including the road conditions through the accelerometer 43 and the gyroscope sensor 44. If a high degree of axial or radial change is detected in a short period of time, the microcontroller 41 will interpret a rough or off-road condition and will set the angle of the light beam to the calibrated position to avoid error in positioning. The error in positioning can occur when the rate of change of the vehicle is greater than the mechanical speed of the reflector 10. For example, if a rate of change of 20 degrees per second during 1 second is detected by the microcontroller 41, the adaptive light beam unit 1 may set the angle and spread of the beam to the calibration position until the rate goes under 10 degrees per second.

Returning to the example of FIG. 1A, the detection of light of an approaching vehicle is carried out by the front light sensor 47 (FIG. 3). The front light sensor 47 is composed of one or multiple light sensors such as: a photodiode, phototransistor, complementary metal oxide semiconductor photo sensor, or a photo resistor of any photosensitive semiconductor device, and combinations thereof. The microcontroller 41 reads the front light sensor multiple times per second, which may be between 2 to 25 times per second depending on the microcontroller speed. Each result is stored in a volatile memory and calculated with a precedent value to establish the common light level for the previous second. For example, if the light sensor input is read ten times per second, these ten values are mixed with the last 90 values to determine the common light level for the last ten seconds. The microcontroller 41 records a common value for each defined period of time and stores in a volatile memory for use in the near future. For example, if the microcontroller 41 stores in volatile memory the common value for the last ten seconds, the microcontroller 41 also compares the value of the previous second with the nine previous seconds, if the new common value is higher than the previous common value, the adaptive light beam unit 1 sets a flag in volatile memory for a set period of time.

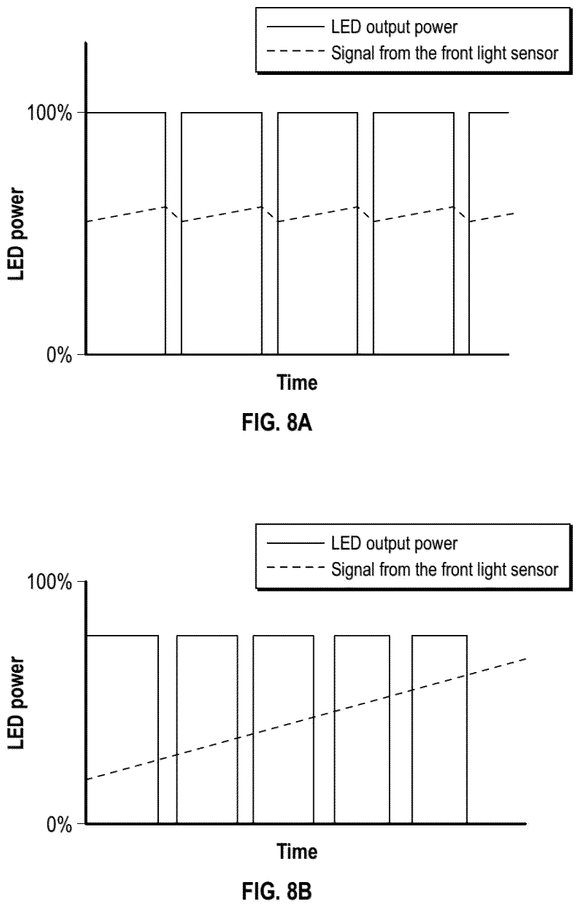

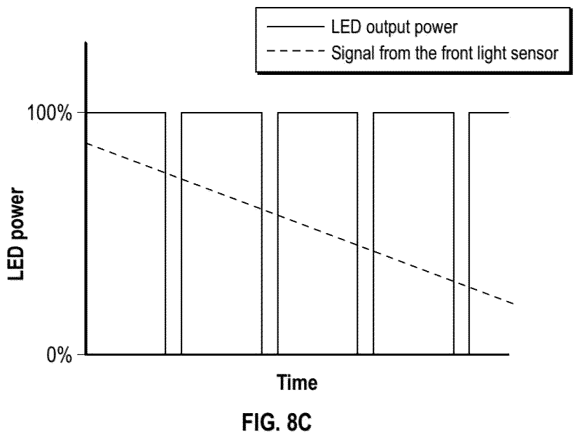

FIGS. 8A, B and C demonstrate how the microcontroller 41 determines if the front light sensor 47 is being triggered by its own light source or that of another light source. The microcontroller 41 makes rapid interruptions in the LED output to verify if there is any change in the light detection of the front light sensor 47. FIG. 8A demonstrates the scenario of the front light sensor 47 being triggered by its own light source. In this case, when the LEDs are turned off, the signal returned by the front light sensor 47 will be weaker, therefore the microcontroller 41 will infer (calculate as a function of pre-set parameters) that the front light sensor 47 was reading its own light source and will discount the information received. FIG. 8B demonstrates the scenario whereby the front light sensor 47 is being lit by the lights of an approaching vehicle. In this case the signal returned by the front light sensor 47 when the LEDs are turned off continue to grow stronger as the vehicle approaches, therefore the microcontroller 41 will deduce that the front light sensor 47 was reading the light source of an approaching vehicle and will set the light beam to a narrow position. FIG. 8C demonstrates the scenario when the approaching vehicle has passed and the light beam will be returned to its normal state. The interruptions to the LED output are very brief, less than 1/1000 of a second and are not detectable to the human eye.

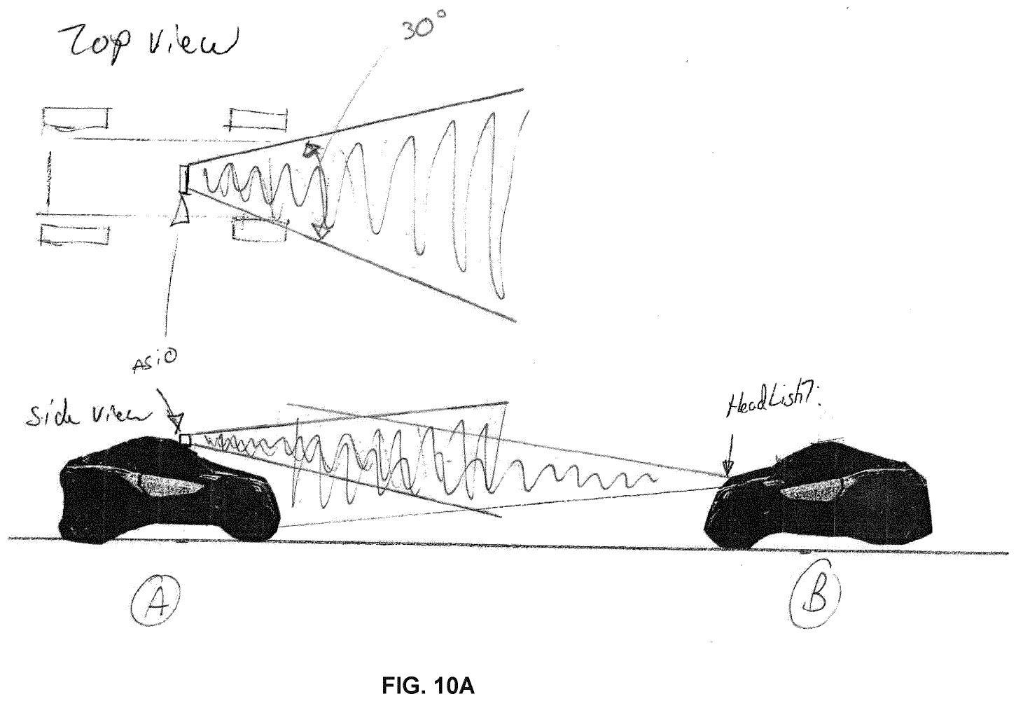

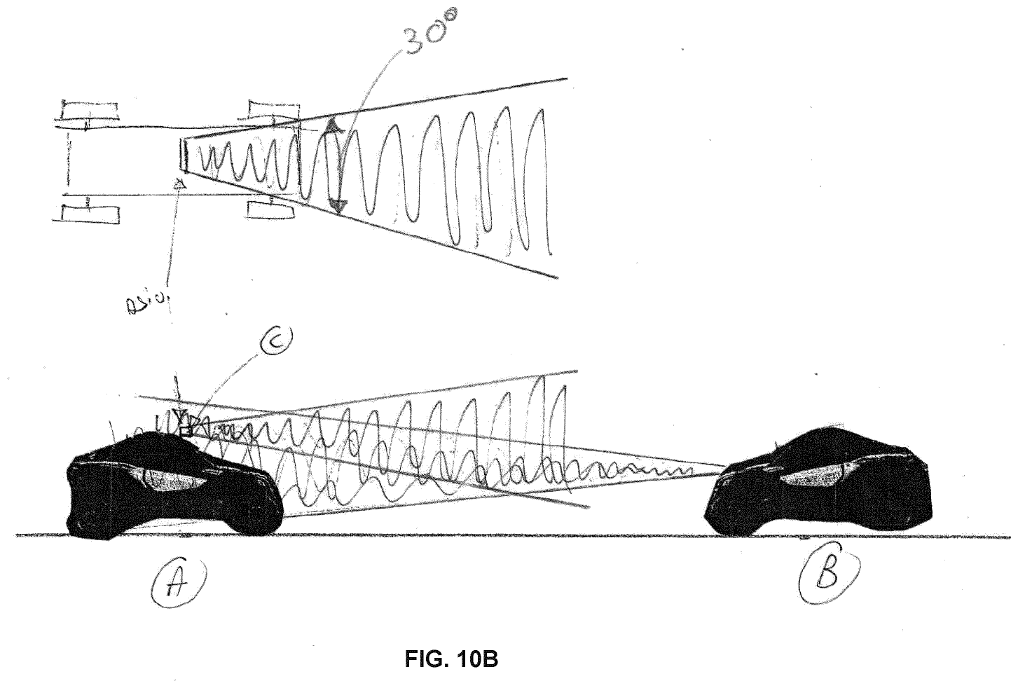

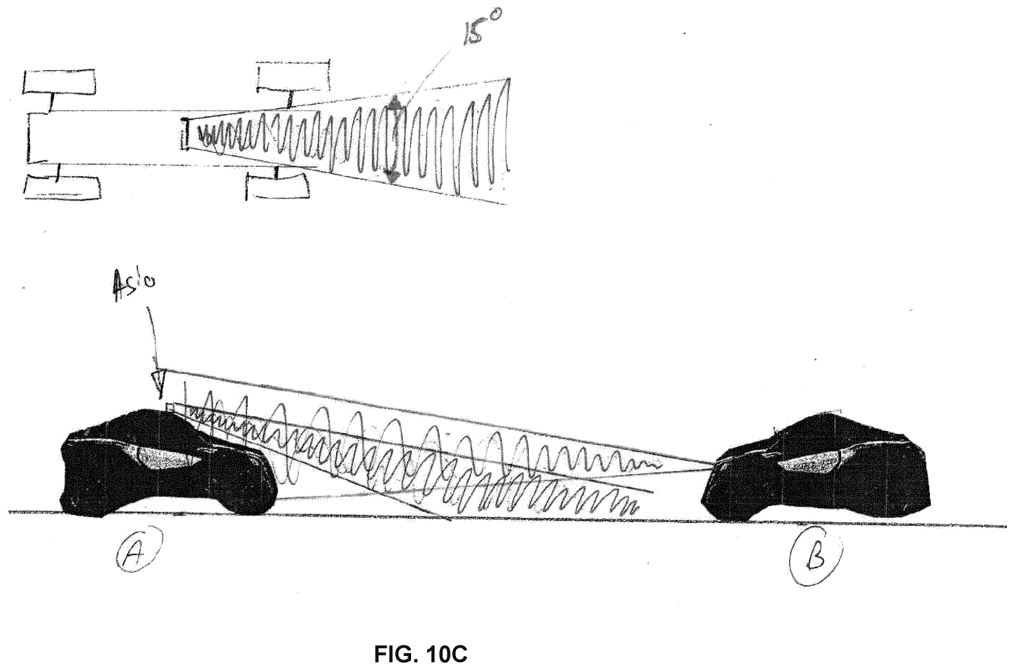

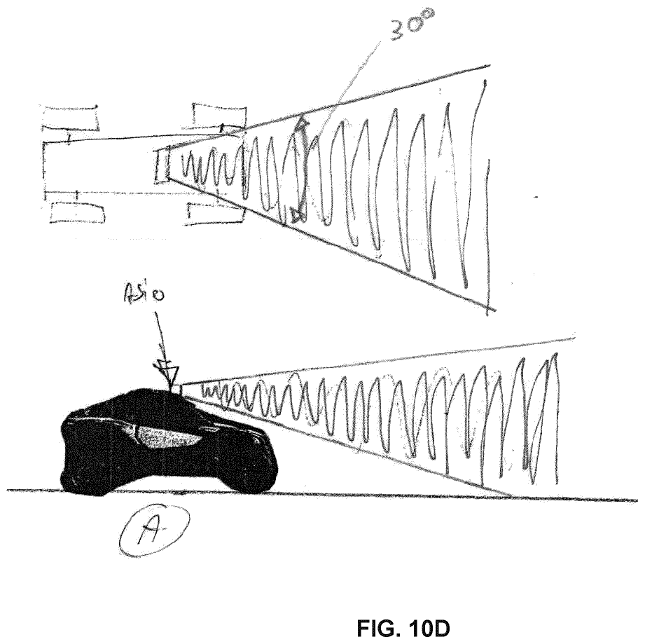

Referring now to FIGS. 10A-10D, in FIG. 10A, vehicle A is depicted with the adaptive light beam unit on the rooftop. The top view of vehicle A provides the angle of light pattern is wide and in this example is 30 degrees. In this scenario, vehicle A and vehicle B are approaching each other. Vehicle A sensor has not yet detected the incident light of vehicle B and therefore the LED bar on the adaptive light beam unit has no constraint in relation to the oncoming vehicle for light position or diffusion pattern.

In FIG. 10B, the lights of vehicle A intersect with the lights of vehicle B and the incident light sensor C of the adaptive light beam unit of vehicle A detects the oncoming lights of vehicle B.

In FIG. 10C, the microcontroller of the adaptive light beam unit of vehicle A receives a signal from the incident light sensor of the adaptive light beam unit and commences a sequential action to the sensing of the incident light of vehicle B. As a result of interpreting vehicle B is oncoming, the microcontroller instructs the adaptive light beam unit in accordance to a predetermined set of instructions. If the adaptive light beam unit comprises a powered movable reflector, the reflector is moved to direct the light beam of vehicle A downwards from the normal position to minimize, preferably to avoid “blinding” the driver of vehicle B. If the light source of the adaptive light beam unit of vehicle A comprises an array of LEDs, the intensity of the LEDs are reduced to further avoid “blinding” the driver of vehicle B. The angle of light pattern is narrow and in this example 15 degrees.

In FIG. 10D, once vehicle A has passed the point of intersection with vehicle B, the microcontroller of the adaptive light beam unit of vehicle A receives a signal from the incident light sensor that vehicle B lights are no longer oncoming and the microcontroller sets the light position and intensity to that of FIG. 10A.

In some examples, the above-described adaptive light beam unit 1 may be autonomous from the vehicle it is installed on, other than the electrical source which provides power to said adaptive light beam unit (said power source could supply alternate current (AC) and voltage or direct current (DC) and voltage, depending on the requirements of the internal components of the adaptive light beam unit). For example, said adaptive light beam unit may not require receiving speed readings or angular momentum information (pitch, roll or yaw) from the vehicle on which it is installed. The adaptive light beam unit may also operate without any of its components being installed on other portions of the vehicles. For example, the adaptive light beam unit may function without any component installed on the wheels, the rear or on the sides of the vehicle with the adaptive light beam unit mounted on the front of the vehicle.

Alternatively, the light beam unit 1 may have its own power source, such as a battery, the unit then being independent from the vehicle battery or magneto generator, thus completely autonomous from the vehicle on which it is installed other than from the mechanical assembly to this vehicle.

In some examples, such autonomous adaptive light beam unit 1 may be packaged in a single housing (casing) which may be mechanically attached to vehicles, using only AC power or DC power from the vehicle, or alternatively having an autonomous energy source, whether enclosed or not in this single housing. Examples receiving AC or DC power from the vehicles may require only electrical connections (a power cable) to the main power supply of the vehicle in addition to the mechanical assembly to this vehicle. This makes it possible to easily attach and detach the adaptive light beam unit from the vehicle and quickly attach it to another vehicle. For example, a user may want to install the adaptive light beam unit on a quad-vehicle during the summer, and attach it to a snowmobile during winter. Furthermore, the adaptive light beam unit may be attached to other vehicles which have no integrated pitch, yaw or roll sensors. Such transfer to other vehicles may, in some examples, be performed simply by disconnecting the power from a first vehicle, detaching the device from the first vehicle, attaching the device to the second vehicle, and connecting it to the second vehicle's power source. Thereafter, the device may be calibrated as described above.

The unit of the present disclosure may also be used with vehicles that have at least one of a yaw, pitch or roll sensor. The advantage of the unit described herein is that the yaw, pitch and/or roll sensors of the unit described herein are integrated in a single unit and thus does not need access to sensors within the vehicle.

Thus one further advantage of the unit with integrated sensors of the present disclosure is the adaptability to be used in vehicles with and without sensors. In other words, there is no need to access the existing sensors in a vehicle to use the unit of the present disclosure.

Yet another advantage of having an autonomous adaptive light beam unit 1 is to diminish the risk of infiltration of water, dirt, oil or dust within the device, which may cause failure of the device. In some examples, the device is packaged in a single casing which is designed to be water, dust and dirt resistant. For example, the casing may be certified IP67k (in accordance with international standard IEC 60529 for protection against solid and liquid intrusion). This would prevent damage to the components, such as corrosion of the electrical circuits, or a short-circuit due to solid intrusions into the housing. Also, the casing may be designed to absorb impact energy in case of an impact, such as a high velocity impact, protecting the electronic and electromechanical components of the adaptive light beam unit from impact damage.

Furthermore, when the unit is packaged in a single casing, the adaptive light beam unit does not have wires running through or across the vehicle between the components, except a power cable to the main power supply of the vehicle. Such additional wires may be vulnerable to being severed by moving parts of the vehicle, and also to corrosion and to projections from the road. This may be problematic especially for off-road vehicles operating on various wet, muddy or snowy terrains. Having a single sealed casing, the device may be usable in even highly humid and/or dusty environments.

Also, when the device is in a single casing, there is no need to level the components in relation to one another during the installation of the device, each being mechanically secured to the same casing. This is advantageous notably for the pitch and roll sensors, which do not need separate calibration when packaged together with light projection angle control components.

The adaptive light beam unit 1 may further include a wireless communication component, such as a Bluetooth, a Wi-Fi, Wi-Fi HaLow or a ZigBee communication module (which may be integrated with or separate from the controller), such wireless communication component being connected to the controller of the adaptive light beam unit. For example, such setup could be used so that a user, using a remote wireless interface (for example a cell phone with a Bluetooth interface and an appropriate application installed on it) could adjust different settings of the adaptive light beam unit, for example the gain on the signal from the sensors, reaction delays for the adaptive light beam unit, maximum angles of deviation of the beam etc.

Such wireless communication component may also (or alternatively) be used by the user to collect information on the operation of the adaptive light beam unit, such as the maximum measured G-force or the roughness of the terrain during operation of the vehicle. The information may be collected by the controller during operation, then forwarded to the user's remote wireless interface, either during (real time) or post operation of the adaptive light beam unit.

The adaptive light beam unit 1 may also be mounted on an electric vehicle, plane, crane, boat, motor bike, bicycle, all-terrain vehicle, snowmobile, utility task vehicle, and sport utility task vehicle. For example, the adaptive light beam unit 1 could be used on a plane to compensate, for example, for the pitch at takeoff and landing. Alternatively, it may also be used on a crane to compensate for the pitch variations caused by the boom. In another example, it could be used on a boat to compensate for the pitch and roll caused by waves.

1-32. (canceled)

33. An adaptive light beam unit, attachable to a vehicle, the adaptive light beam unit comprising:
at least one light engine assembly, wherein said at least one light engine assembly comprises at least one light engine, said at least one light engine comprises at least one light source and at least one reflector adapted to reflect light emitted from said at least one light source to form a light beam;
at least one sensor for measuring angle of rotation of said vehicle;
at least one controller operatively connected to said least one light engine assembly and said at least one sensor, whereby said at least one controller receives information on said angle of rotation of said vehicle, and drives the adaptive light beam unit for maintaining and/or altering a projection angle of said light beam such that a desired lighting positioning is obtained based on a pre-determined scenario.

34. An adaptive light beam unit, attachable to a vehicle, the adaptive light beam unit comprising:
at least one light engine assembly, wherein said at least one light engine assembly comprises at least one light engine, said at least one light engine comprises at least one light source and at least one reflector adapted to reflect light emitted from said at least one light source to form a light beam;
at least one sensor for measuring angle of rotation of said vehicle;
at least one motor connected to said at least one light engine assembly for changing a projection angle of said light beam;
at least one controller operatively connected to said least one light engine assembly and said at least one sensor, whereby said at least one controller receives information on said angle of rotation of said vehicle, and drives said at least one motor to maintain and/or alter said projection angle of said light beam such that a desired lighting positioning is obtained based on a pre-determined scenario.

35. The adaptive light beam unit of claim 33, wherein said at least one light source is selected from a group consisting of a light emitting diode, high intensity discharge lamp, organic light emitting diode, laser exiting phosphor, xenon lamp and combinations thereof.

36. The adaptive light beam unit of claim 34, wherein said at least one light source is selected from a group consisting of a light emitting diode, high intensity discharge lamp, organic light emitting diode, laser exiting phosphor, xenon lamp and combinations thereof.

37. The adaptive light beam unit of claim 33, wherein said at least one sensor is selected from a group consisting of a thermal sensor, light sensor, 3-axis accelerometer, input voltage sensor gyroscope sensor and combinations thereof.

38. The adaptive light beam unit of claim 34, wherein said at least one sensor is selected from a group consisting of a thermal sensor, light sensor, 3-axis accelerometer, input voltage sensor gyroscope sensor and combinations thereof.

39. The adaptive light beam unit of claim 33, wherein said angle of rotation comprises at least one of pitch, roll or yaw.

40. The adaptive light beam unit of claim 34, wherein said angle of rotation comprises at least one of pitch, roll or yaw.

41. The adaptive light beam unit of claim 33, wherein said at least one reflector is made of material selected from a group consisting of polished aluminium, metalized plastic, reflecting synthetic material, an object coated by physical vapour deposition, ceramic reflective coating, high reflective metallic coating, and combinations thereof.

42. The adaptive light beam unit of claim 34, wherein said at least one reflector is made of material selected from a group consisting of polished aluminium, metalized plastic, reflecting synthetic material, an object coated by physical vapour deposition, ceramic reflective coating, high reflective metallic coating, and combinations thereof.

43. The adaptive light beam unit of claim 33, wherein said at least one reflector has a shape selected from a group consisting of: parabolic, spherical, flat plane, hyperbolic, ellipsoidal, and a custom shape for a custom light diffusion pattern.

44. The adaptive light beam unit of claim 34, wherein said at least one reflector has a shape selected from a group consisting of: parabolic, spherical, flat plane, hyperbolic, ellipsoidal, and a custom shape for a custom light diffusion pattern.

45. The adaptive light beam unit of claim 33, wherein said controller is selected from a group consisting of: a microcontroller, programmable logic controller, complex programmable logic device, programmable logic device, application-specific integrated circuit, a combination of an analogue comparator and logic device, and combinations thereof.

46. The adaptive light beam unit of claim 34, wherein said controller is selected from a group consisting of: a microcontroller, programmable logic controller, complex programmable logic device, programmable logic device, application-specific integrated circuit, a combination of an analogue comparator and logic device, and combinations thereof.

47. The adaptive light beam unit of claim 33 further comprising at least one secondary sensor for measuring incident lighting on said adaptive light beam unit and sending measurement of said incident lighting to said at least one controller, and whereas said at least one controller receives information on said incident lighting driving said at least one motor to alter said projection angle of said light beam when such incident lighting is above a pre-determined threshold.

48. The adaptive light beam unit of claim 34 further comprising at least one secondary sensor for measuring incident lighting on said adaptive light beam unit and sending measurement of said incident lighting to said at least one controller, and whereas said at least one controller receives information on said incident lighting driving said at least one motor to alter said projection angle of said light beam when such incident lighting is above a pre-determined threshold.

49. The adaptive light beam unit of claim 33 further comprising at least one tertiary sensor measuring temperature of said at least one light engine assembly and sending measurement of said temperature to said at least one controller, and whereas said at least one controller receives information on said temperature sending a command to alter power of said at least one light engine assembly such that an acceptable thermal range of said at least one light engine assembly is maintained.

50. The adaptive light beam unit of claim 34 further comprising at least one tertiary sensor measuring temperature of said at least one light engine assembly and sending measurement of said temperature to said at least one controller, and whereas said at least one controller receives information on said temperature sending a command to alter power of said at least one light engine assembly such that an acceptable thermal range of said at least one light engine assembly is maintained.

51. The adaptive light beam unit of claim 33 further comprising at least one quaternary sensor measuring at least one of acceleration, g-force and incident lighting, and whereas said at least one controller receives information on said at least one of acceleration, g-force and incident lighting sending a command to select said at least one light source such that an acceptable angle of diffusion is selected.

52. The adaptive light beam unit of claim 34 further comprising at least one quaternary sensor measuring at least one of acceleration, g-force and incident lighting, and whereas said at least one controller receives information on said at least one of acceleration, g-force and incident lighting sending a command to select said at least one light source such that an acceptable angle of diffusion is selected.

53. The adaptive light unit of claim 33, wherein said at least one light engine, said at least one sensor, said at least one motor of claim 34 and said at least one controller are enclosed in a single housing.
